(19) United States
(12) Patent Application Publication
(10) Pub. No.: US 2007/0091644 A1
(43) Pub. Date: Apr. 26, 2007

(54) Backlight unit and liquid crystal display apparatus with the same mounted thereon

(76) Inventor: Tomokazu Fujishima, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/580,855

(22) Filed: Oct. 16, 2006

(30) Foreign Application Priority Data
Oct. 26, 2005 (JP) 311107/2005

(51) Int. Cl. F21V 7/04; F21V 23/04

(52) U.S. Cl. 362/630; 362/632; 362/276

(57) ABSTRACT

Provided is a backlight unit which includes a frame-shaped chassis, a light guide plate, a light source, a photodetector, and a shield plate. The light guide plate is disposed inside the chassis. The light source is disposed on one edge face of the light guide plate, and a photodetector for detecting light leaked out of the other edge face is disposed on the other edge face of the light guide plate opposed to the light source. A shield plate is disposed at the side of the back surface of the light guide plate, and both the light guide plate and the photodetector are fastened to the shield plate.

### BACKGROUND OF THE INVENTION

1. Field of the Invention

The present invention relates to the structure of a backlight unit, and to a liquid crystal display apparatus with the backlight unit mounted thereon.

2. Description of the Related Art

A liquid crystal display apparatus is characterized in that it is small-sized, thin, and light in weight, and that it consumes a small amount of electric power. Therefore it is widely used for office automation equipment, a monitor of a TV set and the like. This liquid crystal display apparatus includes a liquid crystal panel and a backlight unit. The liquid crystal panel has a structure in which liquid crystal is interposed between transparent substrates facing each other. The backlight unit generates backlight that illuminates the liquid crystal panel.

Moreover, the backlight units are roughly classified into a direct light type, an edge light type and a surface light source type. In the direct light type, a light source is disposed on the back of the liquid crystal panel, and the light emitted from the light source is reflected by a reflector. In the edge light type (also referred to as a side light type), the light source is disposed to the side of the liquid crystal panel, and the light emitted from the light source is guided by a light guide plate to the entire area of the back surface of the liquid crystal panel. In the surface light source type, the surface light source is disposed in the entire back surface of the liquid crystal panel, and the light emitted from the surface light source is directly irradiated on the liquid crystal panel. The liquid crystal display apparatus of a thin type usually uses the backlight unit of the edge light type.

The edge light type of the backlight unit includes a chassis, a light guide plate, a light source, an optical member and a shield plate. The chassis holds and fixes other constituent members. The light guide plate is disposed inside the chassis. The light source is disposed to the edge face of the light guide plate. The optical member is disposed at the side of the front surface of the light guide plate (at the side of the liquid crystal panel), and uniforms the light coming from the light guide plate, irradiating the light on the liquid crystal panel. The shield plate is disposed at the side of the back face of the light guide plate (opposite side to the liquid crystal panel), and reflects the light toward the side of the liquid crystal panel, the light going from the light guide plate to side of the back face.

A Cold Cathode Fluorescent Lamp (CCFL), a Light Emitting Diode (LED) and the like have been used as the light source of the backlight unit. In the case of these light sources, luminance is reduced and chromaticity is changed when the light sources are lit for a long time. Therefore, in order to keep constant brightness and chromaticity of the display surface of the liquid crystal display apparatus, it is proposed to mount a photodetector on the backlight unit, the photodetector detecting the light emitted from the light source.

For example, JP-10-22208A (1998 (Document 1)) discloses a method in which a photosensor is mounted on the back surface of the liquid crystal display apparatus for detecting the light leaked out of the back light by means of this photosensor, and thereby to control the emission intensity of the light source based on the detection result. The structure described in Document 1 detects the light leaked out of the reflection sheet on the back surface of a light guide plate. Therefore, with the structure described in Document 1, it is difficult to accurately measure the reduction in luminance and the change in chromaticity.

Therefore, a structure for detecting the light leaked out of the side of the liquid crystal display apparatus is proposed. For example, JP 2004-199968A (Document 2) discloses a liquid crystal display apparatus provided with a light guide plate for guiding the light incident from one side of the light guide plate to the entire surface and a photosensor for receiving the light going out of the other side of the light guide plate. This liquid crystal display apparatus controls the emission intensity of the light source based on the intensity of the light which the photosensor detects.

The conventional back light unit of the edge light type such as the above is described with reference to FIGS. 5 to 8B. FIG. 5 is a perspective view showing the construction of the conventional backlight unit, and illustrates the structure viewed from the side of the back surface of the liquid crystal display apparatus. FIG. 6 is a cross-sectional view taken along the line C-C of FIG. 5, and illustrates an enlarged view of the part in which the light guide plate is fastened with a light guide plate fastening screw. FIG. 7 is a cross-sectional view taken along the line D-D of FIG. 5, and illustrates an enlarged view of the part in which a photodetector is fastened. FIGS. 8A and 8B are a plan view and a side view which show the structure of a shield plate 3 of FIG. 5, respectively.

As shown in FIG. 5, the conventional backlight unit includes a frame-shaped chassis 1, a light guide plate 2 disposed inside the chassis 1, a shield plate 3 disposed at the side of the back surface of the light guide plate, and a light source (not shown) disposed to one edge face of the light guide plate 2. A light guide plate fastening screw 4a and a photodetector 5 are provided to the other edge of the light guide plate 2 opposite to the light source. It should be noted that FIG. 5 shows the shield plate 3 partially broken.

As shown in FIG. 6, the light guide plate fastening screw 4a is passed through a hole provided on the side face of the chassis 1, and is screwed into a threaded hole formed on the edge face of the light guide plate 2 to fasten the chassis 1 and the light guide plate 2.

As shown in FIG. 7, the photodetector 5 is disposed in the position corresponding to the hole formed on the chassis 1. As shown in FIGS. 8A and 8B, the photodetector 5 is fastened to threaded holes 5a and 5b for attaching the photodetector in a bended portion of the shield plate 3. The photodetector 5 detects the light which is leaked through a light transmission hole 5c of the shield plate 3 from the edge face (face E of FIG. 7) of the light guide plate 2.

As described above, in the conventional backlight unit, the photodetector 5 is fastened together with the shield plate 3 by screws. The light guide plate 2 is fastened together with the chassis 1 by a screw. That is, the photodetector 5 and the light guide plate 2 are not directly fastened together, but are indirectly fastened by means of two members including the shield plate 3 and the chassis 1.

Here, considered is a case where the light leaked out of the edge face (face E of FIG. 7) is detected by means of the photodetector 5. The intensity of the light detected by the photodetector 5 is varied depending on the distance between the edge face of the light guide plate and the light incident section of the photodetector 5. Therefore, it is necessary to maintain a constant positioning relationship between them. However, as described above, the photodetector 5 and the light guide plate 2 are not directly fastened, but are indirectly fastened by means of the shield plate 3 and the chassis 1. Thus, the distance between the face E of the light guide plate and the light incident section of the photodetector 5 is not always stable.

In particular, the light guide plate 2 is generally made of resin, and thus expands and contracts due to temperature. A certain amount of clearance is provided between the light guide plate 2 and the other constituent members in order that the expansion and contraction of the light guide plate 2 may not give distortion to the other constituent members. Therefore, assembly variations are prone to occur when fastening the constituent members to one another. In particular, the distance between the photodetector 5 and the light guide plate 2 varies in each product due to the accumulation of the variations in the assembly of the shield plate 3 and the chassis 1. As a result, this causes variations in the detection accuracy of the photodetector 5.

Moreover, the chassis 1 is generally formed of resin to reduce its cost and mass in many cases. Therefore, when the light guide plate 2 with a large mass is fastened on the chassis 1, distortion is generated in this fastening section. Accordingly, stress is given to the liquid crystal panel on which this backlight unit is attached. This stress generated on the display panel causes uneven display quality of the liquid crystal display apparatus. In addition, when each of the constituent members is not appropriately fastened, impact resistance of the liquid crystal display apparatus itself is reduced.

### SUMMARY OF THE INVENTION

A first exemplary feature of the invention provides a backlight unit which can accurately define the positioning relationship between a photodetector and a light guide plate to improve the detection accuracy of the photodetector.

According to the first exemplary aspect of the invention, there is provided a backlight unit which includes a frame-shaped chassis, a light guide plate, a light source, a photodetector, and a shield plate. The light guide plate is disposed inside the chassis. The light source is disposed on one edge face of the light guide plate. On the other edge face of the light guide plate opposite to the light source, the photodetector is disposed to detect the light leaked out of this other edge. The shield plate is disposed at the side of the back surface of the light guide plate. Both of the light guide plate and the photodetector are fastened to this shield plate.

In this way, according to the first exemplary aspect of the invention, both of the photodetector and the light guide plate are fastened to the shield plate. Therefore, the positioning relationship can be accurately defined between the photodetector and the light guide plate. This improves the detection accuracy of the photodetector.

### BRIEF DESCRIPTION OF THE DRAWINGS

The above and other objects, features and advantages of the present invention will become apparent from the following detailed description when taken with the accompanying drawings in which:

FIG. 1A is a perspective view schematically showing the construction of a backlight unit according to an embodiment of the present invention;

FIG. 1B is a block diagram showing a configuration example of the light source intensity adjustment mechanism;

FIG. 2 is a partially enlarged view of the backlight unit according to an embodiment of the present invention, and a cross-sectional view taken along the line A-A of FIG. 1A;

FIG. 3 is a cross-sectional view taken along the line B-B of FIG. 1A;

FIG. 4A is a plan view exemplifying a structure of a shield plate 3a of FIG. 1A;

FIG. 4B is a side view exemplifying the structure of the shield plate 3a of FIG. 1A;

FIG. 5 is a perspective view schematically showing the construction of the conventional backlight unit;

FIG. 6 is a cross-sectional view taken along the line C-C of FIG. 5;

FIG. 7 is a cross-sectional view taken along the line D-D of FIG. 5;

FIG. 8A is a plan view of a construction of a shield plate 3 of FIG. 5; and

FIG. 8B is a side view of the construction of the shield plate 3 of FIG. 5.

### DETAILED DESCRIPTION OF THE PREFERRED EMBODIMENTS

As described in the “BACKGROUND OF THE INVENTION”, since luminance is reduced and chromaticity is changed over time in the light source used in the conventional backlight unit, the liquid crystal display apparatus preferably has a structure in which a photodetector for detecting the light leaked out of the side face is mounted on a backlight unit in order to keep constant brightness and chromaticity of the display surface of the liquid crystal display apparatus. In the conventional backlight unit, the photodetector has been fastened to the shield plate, and the light guide plate has been fastened to the chassis. That is to say, the photodetector and the light guide plate have been indirectly fastened by means of the chassis and the shield plate.

However, the intensity, of the light detected by the photodetector is varied depending on the distance between the photodetector section and the edge portion of the light guide plate. The assembly variations of the constituent members have caused the distance between the photodetector and the light guide plate to vary, thereby resulting in reduction in detection accuracy of the photodetector. In addition, the structure in which the light guide plate of a large mass is fastened only to the chassis also has caused distortion in the fastening portion to cause stress to a liquid crystal panel. This stress caused uneven display quality in the liquid crystal display apparatus in some cases.

One may consider that the solutions to such problems include strengthening the structure of each of the constituent members, adding other members for reinforcement and doing the like. However, these solutions lead to increase in weight of the backlight unit, and increase in size of the liquid crystal display apparatus. Thus, these solutions are not necessarily preferable for the liquid crystal display apparatus for which reduction is required in size, weight and thickness.

This exemplary embodiment relieves the problems caused by varied distances between the photodetector and the light guide plate.

Specifically, in this exemplary embodiment, the light guide plate is fastened to the shield plate, and the photodetector is also fastened to the same shield plate. This makes it possible to accurately define the positioning relationship between the photodetector and the light guide plate to improve the detection accuracy of the photodetector. Secondarily, this makes it possible to suppress the distortion of the constituent members, to reduce the stress applied on the liquid crystal panel, and to improve the rigidity of the entire backlight unit.

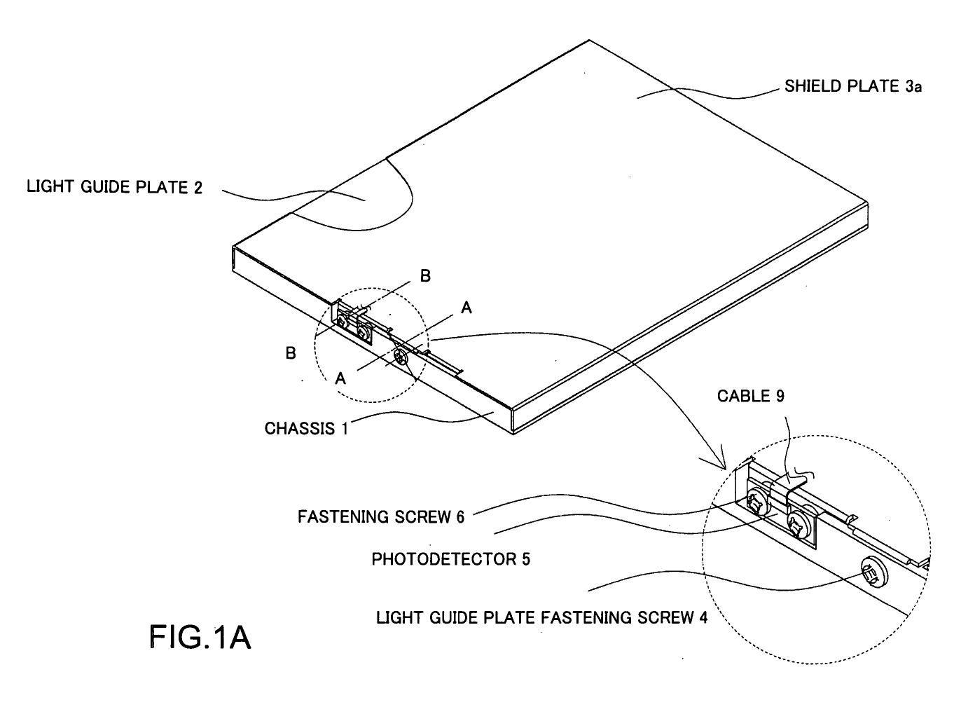

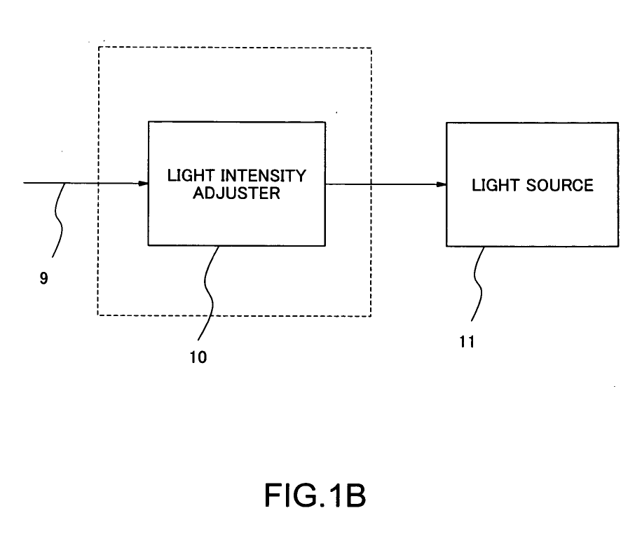

Next, this exemplary embodiment will be described with reference to FIGS. 1A to 4B.

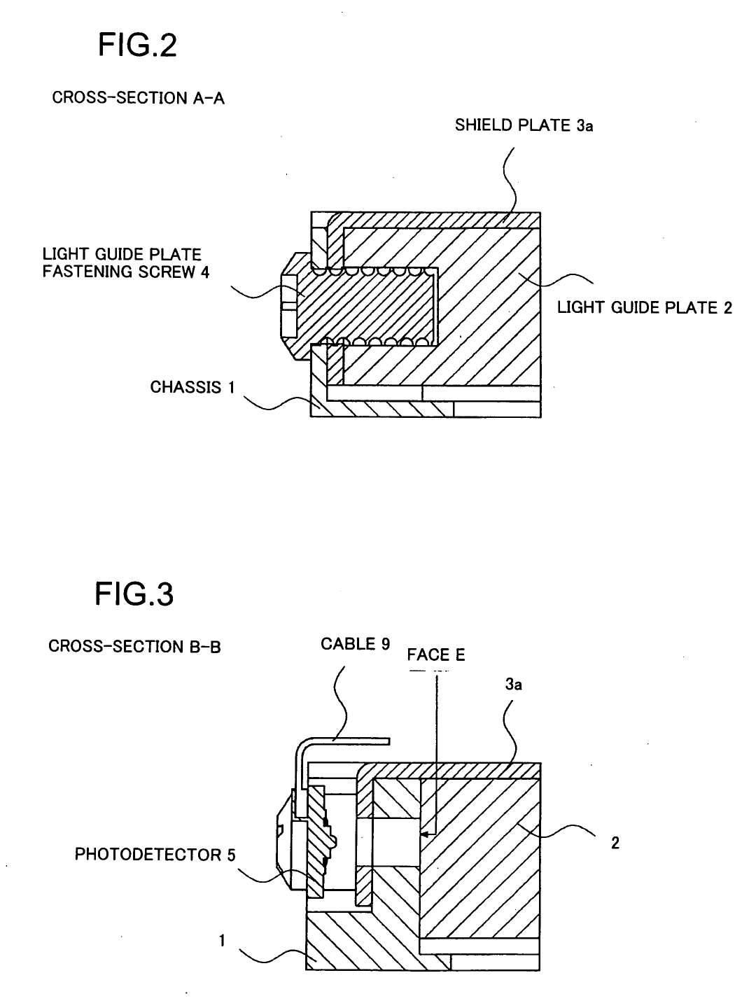

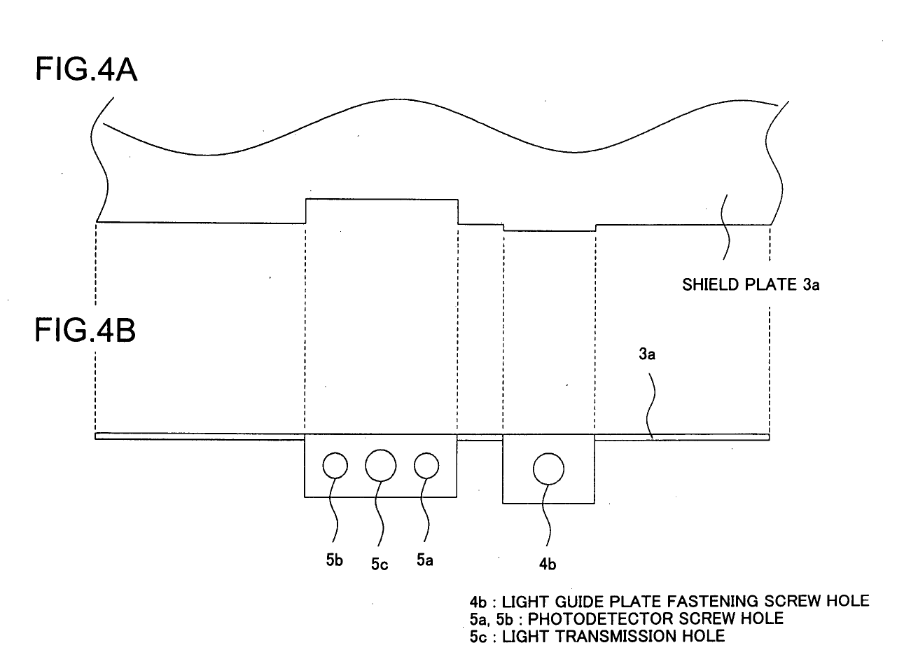

FIG. 1A is a perspective view showing a structure of main constituent members of a backlight unit of this exemplary embodiment, and illustrates the structure viewed from the side of the back surface (the opposite side to the liquid crystal panel). FIG. 1B is a block diagram showing a configuration example of the light source intensity adjustment mechanism. FIGS. 2 and 3 are partial cross-sectional views in which parts of FIG. 1A are enlarged. FIGS. 4A and 4B are a plan view and a side view showing the structure of a shield plate 3a in this exemplary embodiment, respectively.

The liquid crystal display apparatus of this exemplary embodiment includes, as main constituent elements, a liquid crystal panel (not shown, and not restricted in shape, structure and driving method), and the backlight unit of the edge light type which irradiates back light on the liquid crystal panel.

The liquid crystal panel includes a first substrate, a second substrate, and liquid crystals interposed between the first and second substrates. Switching elements such as thin film transistors (TFT) are arranged in a matrix pattern on the first substrate. A color filter and a black matrix are formed on the second substrate. The present invention is characterized by the structure of the backlight unit, and is not particularly limited in the structure of the liquid crystal panel (such as a top gate type and a bottom gate type), the driving method of the liquid crystal (such as IPS (In-Plane Switching) method and TN (Twisted Nematic) method), and a mounting structure. These are technologies well-known by those skilled in the art. Therefore, further description is omitted about the liquid crystal panel.

As shown in FIG. 1A, the backlight unit of this exemplary embodiment includes a chassis 1, a light guide plate 2, a light source (not shown), a shield plate 3a, a light guide fastening screw 4, a photodetector 5, and a cable 9 for transmitting the output of the photodetector.

The chassis 1 holds and fixes each constituent member.

The light guide plate 2 is disposed inside the chassis 1, and at least one light source is disposed to one edge of the light guide plate 2. A CCFL, an LED and the like are used as this light source. Optical members (not shown) such as a diffusion sheet, a lens sheet and a polarization sheet are disposed at the side of the front surface of the light guide plate 2 (at the side of the liquid crystal panel). These optical members uniform the light coming from the light guide plate 2, and guide the light to the liquid crystal panel. The light guide plate 2 is fastened to the shield plate 3a by means of the light guide plate fastening screw 4 (refer to FIG. 2).

The shield plate 3a is disposed at the side of the back surface of the light guide plate 2 (at the side opposite to the liquid crystal panel), and reflects the light to the side of the light guide plate 2, the light being directed from the light guide plate 2 to the side of the back surface.

The photodetector 5 is provided to the side of the edge face opposed to the other edge face where the light source of the light guide plate 2 is disposed. The photodetector 5 is fastened to the shield plate 3a. The output of the photodetector is transmitted via the cable 9 to a light intensity adjuster.

As described above, in this exemplary embodiment, both of the light guide plate 2 and the photodetector 5 are fastened to the shield plate 3a.

The structure shown in FIG. 1A is just an example, and does not limit the material and the shape of the chassis 1, the shield plate 3a and the light guide plate 2. However, at least the shield plate 3a is preferably constituted of a metallic plate with a predetermined thickness in order to have strength high enough to fasten the light guide plate 2. In addition, it suffices that the photodetector 5 has a function of converting incident light to an electric signal, and is not particularly limited in its structure and shape. The positions and quantity of the photodetector 5 and the light guide plate fastening screw 4 are not limited to the configuration shown in FIG. 1A. However, it is preferable that the positioning relationship between the photodetector 5 and the light guide plate 2 is accurately defined, and that the photodetector 5 and the light guide plate fastening screw 4 are disposed close to each other, in order to enhance the rigidity of the entire backlight unit. Moreover, the quantity of the light guide plate fastening screw 4 is not limited to one.

FIG. 1B is a block diagram showing the configuration example of a light source intensity adjustment mechanism. This mechanism includes a light intensity adjustor 10. The light intensity adjustor 10 controls the emission intensity of the light source 11 based on the output of the photodetector, the output being supplied via the cable 9. It should be noted that the configuration example of the light intensity adjustor 10 is described in the aforementioned Document 1, so a detailed description about the light intensity adjustor 10 is omitted.

Next, a structure in the proximity of the photodetector 5 and the light guide plate fastening screw 4 of the backlight unit of this exemplary embodiment is described with reference to FIGS. 2, 3, 4A and 4B. FIG. 2 is a cross-sectional view taken along the line A-A of FIG. 1A, and is an enlarged view of a part in which the light guide plate is fastened by the light guide plate fastening screw. FIG. 3 is a cross-sectional view taken along the line B-B of FIG. 1A, and is an enlarged view of a part in which the light leaked from the light guide plate is detected by the photodetector. FIG. 4A is a plan view which exemplifies the structure of the shield plate 3a of FIG. 1A. FIG. 4B is a side view which exemplifies the structure of the shield plate 3a of FIG. 1A.

In the conventional backlight unit, the light guide plate fastening screw 4 is passed through the hole provided through the side face of the chassis 1, then is screwed into the threaded hole formed through the edge face of the light guide plate 2, and fastens the light guide plate 2 to the chassis 1.

In this exemplary embodiment, as shown in FIGS. 2 and 4a, the shield plate 3a has a bended portion formed along the edge face of the light guide plate. The light guide plate fastening screw 4 is passed through the hole formed through the side face of the chassis 1 and the bended portion of the shield plate 3a, and is then screwed into the threaded hole formed through the edge face of the light guide plate 2 to fasten together with the chassis 1, the shield plate 3a and the light guide plate 2. Therefore, the light guide plate 2 is fixed not only by the chassis 1 but also by the shield plate 3a having a relatively high strength. Thus, in this exemplary embodiment, it is possible to suppress the distortion of the chassis 1, and to improve the rigidity of the entire backlight unit.

Moreover, as shown in FIGS. 3 and 4B, the photodetector 5 is disposed in the position corresponding to a hole provided to the chassis 1, and is then fastened to holes 5a and 5b in the bended portion of the shield plate 3a by means of fastening screws 6. The photodetector 5 detects the light leaked out of the edge face (face E shown in FIG. 3) of the light guide plate 2 through a light transmission hole 5c of the shield plate 3a.

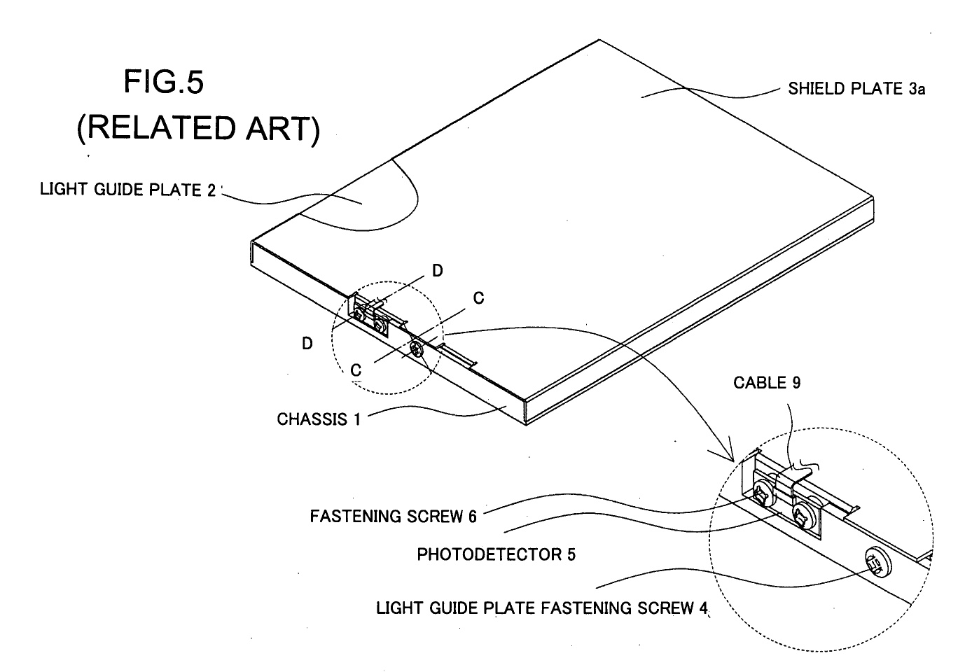

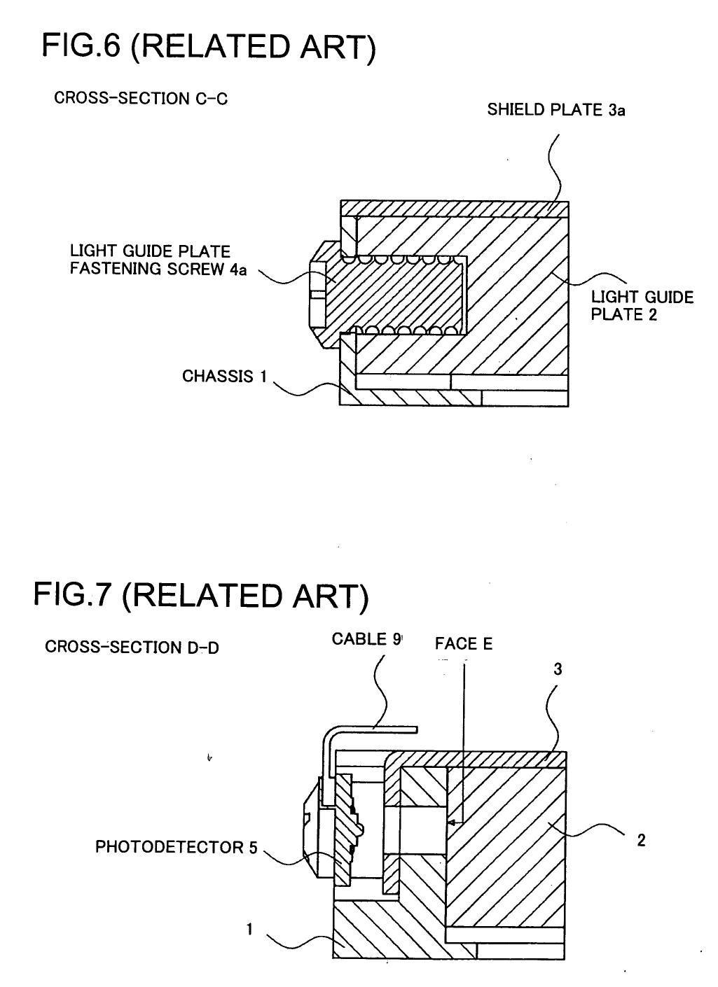

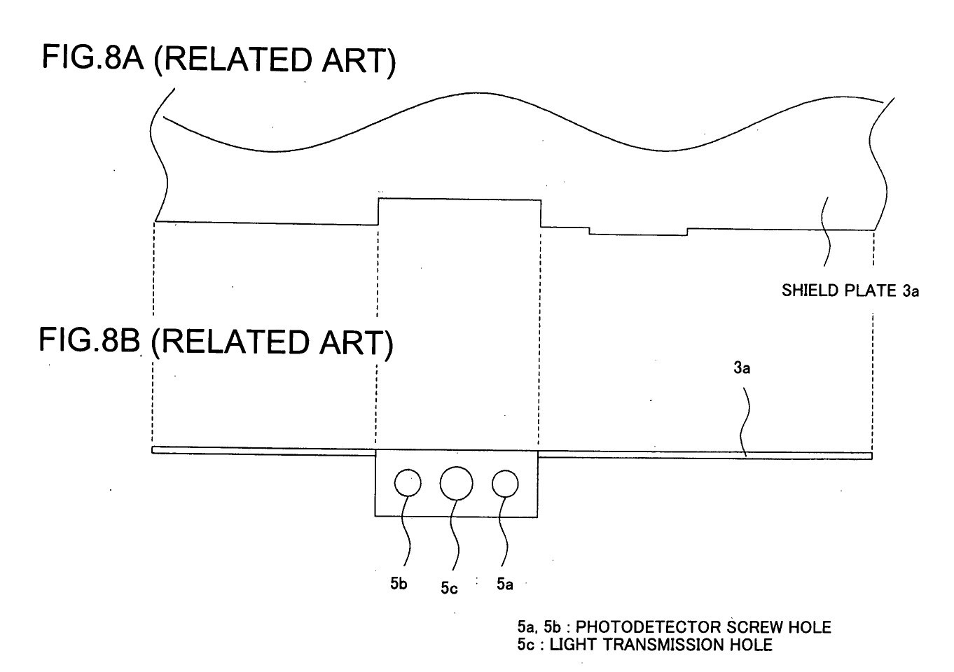

In FIG. 5, the photodetector 5 is fastened to the shield plate 3 by the fastening screws 6. However, the shield plate 3 and the light guide plate 2 are not directly fastened to each other. Therefore, the positioning relationship between the photodetector 5 and the light guide plate 2 cannot be accurately defined.

By contrast, in this exemplary embodiment, as shown in FIGS. 2 and 3, the shield plate 3a and the light guide plate 2 are directly fastened to each other by the light guide plate fastening screw 4. This makes it possible to accurately define the positioning relationship between the photodetector 5 and the light guide plate 2.

As described above, in the backlight unit of this exemplary embodiment, the light guide plate 2 is fastened to the shield plate 3a, and the photodetector 5 is also fastened to the same shield plate 3a. Thus, in this exemplary embodiment, the positioning of both the photodetector 5 and the edge face (face E) of the light guide plate 2 is performed to the same shield plate 3a. Accordingly, it is possible to more accurately determine the positioning relationship between the photodetector 5 and the light guide plate 2 as compared to the conventional structure. As a result, this exemplary embodiment makes it possible to improve the detection accuracy of the photodetector 5. The heavy light guide plate 2 is fastened to not only the chassis 1 but also to the shield plate 3a having a relatively high strength, and thereby the distortion of each of the constituent members, particularly of the chassis 1, can be suppressed to prevent stress from being applied to the liquid crystal panel. Moreover, this exemplary embodiment makes it possible to improve the rigidity and the impact resistance of the entire backlight unit as compared to the conventional technology.

Incidentally, the example has been hereinabove explained in which the light guide plate 2 and the shield plate 3a are fastened with the light guide plate fastening screw 4. However, the present invention does not limit the fastening method to the fastening with a screw. For example, the shield plate 3a and the light guide plate 2 can be fastened to each other by use of a method such as caulking or grappling.

In the above exemplary embodiments, the example has been explained in which the chassis 1 is also fastened to the shield plate together with the light guide plate 2 and the photodetector 5. However, in the present invention, the chassis 1 is not necessarily fastened to both the photodetector 5 and the light guide plate 2.

Moreover, the example has been explained in which the structure of the present invention is applied to the backlight unit of the edge light type. It is apparent that the present invention can be applied to a backlight unit of any type as long as both the photodetector 5 and the light guide plate 2 are fastened to the shield plate 3a.

While this invention has been described in connection with certain exemplary embodiments, it is to be understood that the subject matter encompassed by way of this invention is not be limited to those specific embodiments. On the contrary, it is intended for the subject matter of the invention to include all alternatives, modifications and equivalents as can be included with the sprit and scope of the following claims. Further, the inventor's intent is to retain all equivalents even if the claims are amended during prosecution.

What is claimed is:

1. A backlight unit comprising:
a frame-shaped chassis;
a light guide plate disposed inside the chassis;
a light source disposed on one edge face of the light guide plate;
a photodetector which is disposed at the side of the other edge face of the light guide plate, the edge face being opposed to the light source, and which detects the light leaked out of the other edge face; and
a shield plate disposed, at least, at the side of the back surface of the light guide plate, wherein
both the light guide plate and the photodetector are fastened to the shield plate.

2. The backlight unit as recited in claim 1, wherein both the light guide plate and the photodetector are fastened to the shield plate with predetermined fastening members.

3. The backlight unit as recited in claim 2, wherein the fastening members fasten the chassis, in addition to the light guide plate and the photodetector, to the shield plate.

4. The backlight unit as recited in claim 3, wherein the fastening members include screws.

5. The backlight unit as recited in claim 1, wherein
the shield plate has a bended portion formed along the other edge face of said light guide plate,
the shield plate and the photodetector are fastened with first fastening members in the bended portion, and
the chassis, the shield plate and light guide plate are fastened with a second fastening member in proximity of the first fastening members in the bended part.

6. A liquid crystal display apparatus comprising:
a liquid crystal panel;
a backlight unit which irradiates backlight on the liquid crystal panel, and which includes at least one light source and a photodetector for detecting intensity of the backlight; and
a light emission intensity controller which controls emission intensity of the light source, based on the result of detecting intensity of the backlight,
wherein the backlight unit includes:
a frame-shaped chassis;
a light guide plate disposed inside the chassis;
the light source disposed on one edge face of the light guide plate;
the photodetector which is disposed at the side of the other edge face of the light guide plate, the edge face being opposed to the light source, and which detects light leaked out of the other edge face; and
a shield plate disposed, at least, at the side of the back surface of the light guide plate,
wherein both the light guide plate and the photodetector are fastened to the shield plate.

7. The liquid crystal display apparatus as recited in claim 6, wherein both the light guide plate and the photodetector are fastened to the shield plate with predetermined fastening members.

8. The liquid crystal display apparatus as recited in claim 7, wherein the fastening members fasten the chassis, in addition to the light guide plate and the photodetector, to the shield plate.

9. The liquid crystal display apparatus as recited in claim 8, wherein the fastening members include screws.

10. The liquid crystal display apparatus as recited in claim 6, wherein
the shield plate has a bended portion formed along the other edge face,
the shield plate and the photodetector are fastened with first fastening members in the bended part, and
the chassis, the shield plate and light guide plate are fastened with a second fastening member in proximity of the first fastening members in the bended part.
